(19) United States
(12) Patent Application Publication
(10) Pub. No.: US 2026/0056599 A1
(43) Pub. Date: Feb. 26, 2026

(54) STORAGE SYSTEM, COMPUTER SYSTEM, AND CONTROL METHOD FOR STORAGE SYSTEM

(71) Applicant: Hitachi Vantara, Ltd., Kanagawa-ken (JP)

(72) Inventor: Masanori TAKADA, Tokyo (JP)

(21) Appl. No.: 19/070,414

(22) Filed: Mar. 4, 2025

(30) Foreign Application Priority Data
Aug. 22, 2024 (JP) 2024-141030

(51) Int. Cl. G06F 1/3287

(52) U.S. Cl. CPC G06F 1/3287

(57) ABSTRACT

A storage system includes an interface device including a port connected to communicate with a host operating in a virtual environment, a plurality of the ports configure port groups, and the plurality of ports serve as connection destinations at a time of an access from the host to the storage system. The storage system measures, for each port group, an actual communication load on the port at the time of the accesses from the host to the storage system. The storage system controls power consumption of the interface device based on a comparison result of comparing, for each port group, a communication load with a sum of communication bands of the ports included in each port group.

### CROSS-REFERENCE TO PRIOR APPLICATION

This application relates to and claims the benefit of priority from Japanese Patent Application number 2024-141030, filed on Aug. 22, 2024, the entire disclosure of which is incorporated herein by reference.

### BACKGROUND OF THE INVENTION

### 1. Field of the Invention

The present invention relates to a storage system, a computer system, and a control method for the storage system.

### 2. Description of the Related Art

In recent years, an interest in reducing power consumption of storage systems is increasing. For example, WO 2018/193608 A discloses a storage system equipped with a drive in which the limitation of power consumption is allowed. In this drive, if a writing load exceeds a threshold after the power consumption is limited, the limitation of the power consumption is eased. According to WO 2018/193608 A, the power consumption can be suppressed while the writing performance of the storage system is being maintained.

### SUMMARY OF THE INVENTION

However, the above-described conventional technique does not enable power control of communication ports included in the storage system for a storage to communicate with a server.

The present invention has been made in view of the above problem, and an object of the present invention is to enable the power control of ports provided for a storage to communicate with a server.

In order to achieve the above object, one aspect of the present invention provides a storage system that provides a storage area to a host operating in a virtual environment, the storage system including an interface device including a port connected to communicate with the host, a processor; and a memory, wherein a plurality of the ports configure port groups, the plurality of ports serving as connection destinations at a time of an access from the host to the storage system, and wherein the processor measures, for each of the port groups, an actual communication load on each of the plurality of ports at the time of the access from the host to the storage system, compares, for each of the port groups, the communication load with a sum of communication bands of the plurality of ports included in each of the port groups, and controls power consumption of the interface device based on a comparison result between the communication load and the sum of the communication bands.

According to the present invention, for example, the power control can be made on the ports provided for the storage to communicate with the server.

### BRIEF DESCRIPTION OF THE DRAWINGS

FIG. 1 is a diagram illustrating a configuration of a computer system according to an embodiment;

FIG. 2 shows a configuration of a port specification and state management table according to the embodiment;

FIG. 3 shows a configuration of a port group information management table according to the embodiment;

FIG. 4 shows a configuration of a port flow quantity recording table according to the embodiment;

FIG. 5 is a flowchart showing external data acquisition processing according to the embodiment;

FIG. 6 is a flowchart showing port operation and stop processing according to the embodiment; and

FIG. 7 is a diagram illustrating a configuration of a storage state display screen according to the embodiment.

### DESCRIPTION OF THE PREFERRED EMBODIMENTS

In the following description, an “interface device” may be one or more communication interface devices. The one or more communication interface devices may be one or more communication interface devices of an identical type (for example, one or more network interface cards (NIC)) or two or more communication interface devices of different types (for example, an NIC and a host bus adapter (HBA)).

In the following description, a “memory” is one or more memory devices that are an example of one or more storage devices, and may typically be a main storage device. The at least one memory device in the memory may be a volatile memory device or a non-volatile memory device.

In the following description, a “drive” may be one or more permanent storage devices. Typically, the permanent storage device may be a non-volatile storage device (for example, an auxiliary storage device), and specifically, for example, may be a hard disk drive (HDD), a solid state drive (SSD), or a non-volatile memory express (NVMe) drive.

In the following description, a “processor” may be one or more processor devices. The at least one processor device may typically be a microprocessor device such as a central processing unit (CPU), but may be another type of processor device such as a graphics processing unit (GPU). The at least one processor device may be a single-core or multi-core device. The at least one processor device may be a processor core device. The at least one processor device may be a processor device in a broad sense such as a hardware circuit (for example, a field-programmable gate array (FPGA), a complex programmable logic device (CPLD), or an application specific integrated circuit (ASIC)) that performs a part of or entire processing.

Further, in the following description, information from which an output is obtained with respect to an input may be described using an expression such as “xxx table”. However, the information may be data with any structure (for example, it may be structured data or unstructured data), or may be a learning model represented by a neural network, a genetic algorithm, or a random forest that generates an output with respect to an input. Therefore, the “xxx table” can be referred to as “xxx information”. In the following description, the configuration of each table is an example, and one table may be divided into two or more tables, or all or a part of two or more tables may be one table.

In the following description, processing may be described with a “program” as a subject. However, the program is executed by the processor to execute predetermined processing while appropriately using the storage device and/or the interface device. Therefore, the subject of the processing may be a processor (alternatively, a device such as a controller having the processor). The program may be installed in a device such as a computer from a program source. The program source may be, for example, a program distribution server or a computer-readable (for example, a non-transitory) recording medium. Further, two or more programs may be achieved as one program, or one program may be achieved as two or more programs.

In the following description, a plurality of components assigned with identical reference signs including branch numbers or alphabets will be described using reference signs including branch numbers assigned to the components when being distinguished. On the other hand, when the components are not distinguished, the description will be made while excluding branch numbers and alphabets from the reference signs assigned to the components.

### (Configuration of Computer System S According to an Embodiment)

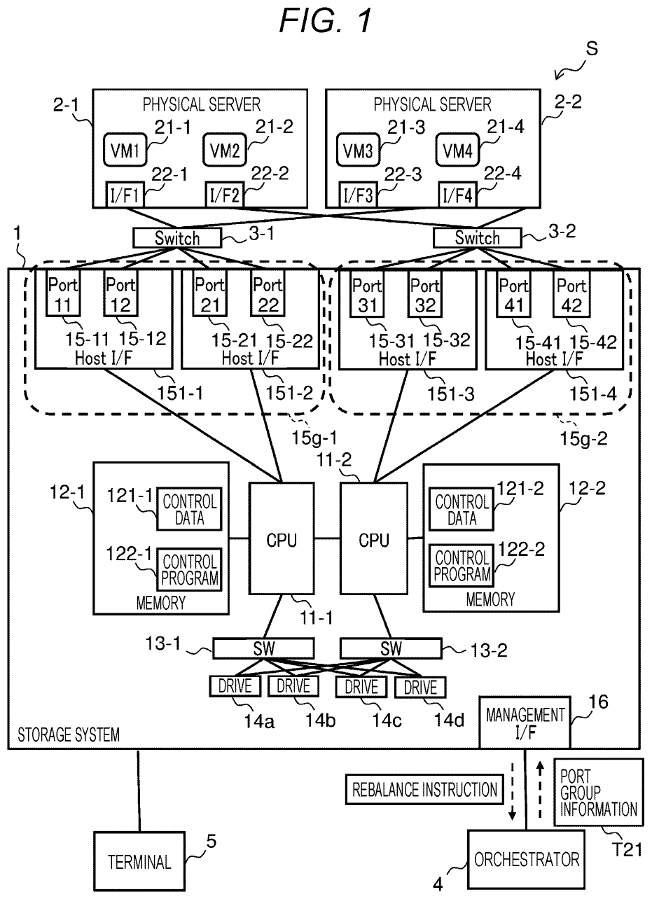

FIG. 1 is a diagram illustrating a configuration of the computer system S according to the embodiment.

The computer system S includes a storage system 1, physical servers 2-1 and 2-2 which are two hosts, switches 3-1 and 3-2, and an orchestrator 4.

The storage system 1 and the physical servers 2-1 and 2-2 are connected respectively via the switches 3-1 and 3-2 constituting a storage area network (SAN). The physical servers 2-1 and 2-2 execute virtual machines 21-1, 21-2, 21-3, and 21-4 which are hosts operating in a virtual environment, and issue commands such as Read and Write to the storage system 1. The hosts operating in the virtual environment are not limited to the virtual machines, and may be virtual servers.

The storage system 1 provides a storage area to the virtual machines 21-1, 21-2, 21-3, and 21-4.

The physical server 2-1 includes an interface (I/F) 22-1 for communicating with the storage system 1 via the switch 3-1, and an I/F 22-2 for communicating with the storage system 1 via the switch 3-2. The physical server 2-2 includes an I/F 22-3 for communicating with the storage system 1 via the switch 3-1 and an I/F 22-4 for communicating with the storage system 1 via the switch 3-2.

The storage system 1 includes CPUs 11-1 and 11-2, memories 12-1 and 12-2, drives 14a, 14b, 14c, and 14d, and host I/Fs 151-1, 151-2, 151-3, and 151-4.

The CPUs 11-1 and 11-2 and the drives 14a to 14d are connected via switches 13-1 and 13-2 having an interface such as serial attached SCSI (SAS) or non-volatile memory host controller interface (NVMe).

The plurality of drives 14a to 14d are grouped in unit of parity groups, and data redundancy is achieved by a high-reliable technique such as redundant arrays of independent disks (RAID).

For communication between the CPUs 11-1 and 11-2 and the host I/Fs 151-1, 151-2, 151-3, and 151-4, a protocol such as fibre channel (FC) or internet protocol (IP) is used.

The host I/F 151-1 includes ports 15-11 and 15-12 serving as connection destinations when the virtual machine 21-1 accesses to the storage system 1. The host I/F 151-2 includes ports 15-21 and 15-22 serving as connection destinations when the virtual machine 21-2 accesses to the storage system 1. The host I/Fs 151-1 and 151-2, that is, the ports 15-11, 15-12, 15-21, and 15-22 constitute a port group 15g-1.

The host I/F 151-3 includes ports 15-31 and 15-32 serving as connection destinations when the virtual machine 21-3 accesses to the storage system 1. The host I/F 151-4 includes ports 15-41 and 15-42 serving as connection destinations when the virtual machine 21-4 accesses to the storage system 1. The host I/Fs 151-3 and 151-4, that is, the ports 15-31, 15-32, 15-41, and 15-42 constitute a port group 15g-2.

The CPUs 11-1 and 11-2 execute various processes using control data 121-1 and 121-2, control programs 122-1 and 122-2, management information, and the like stored in the memories 12-1 and 12-2. Further, the CPU 11-1 and the CPU 11-2 communicate with each other, secure synchronization and consistency of data such as the control data 121-1 and 121-2, and execute various processing.

The memories 12-1 and 12-2 store the control data 121-1 and 121-2, programs such as the control programs 122-1 and 122-2 executed respectively by the CPUs 11-1 and 11-2, the management information used by the programs, and the like. The memories 12-1 and 12-2 are used for other information, for example, for storing a cache of data at a time the physical servers 2-1 and 2-2 makes access.

A management I/F 16 is an interface for the storage system 1 to communicate with the orchestrator 4 that manages a virtualization infrastructure. A connection line between the CPUs 11-1 and 11-2 and the management I/F 16 is not illustrated.

The orchestrator 4 manages execution of the virtual machines 21-1, 21-2, 21-3, and 21-4 in the physical servers 2-1 and 2-2. Further, the orchestrator 4 sets a port group 15g in which a load on the storage system 1, which is a destination of an access from each virtual machine is distributed to the ports 15-11, 15-12, 15-21, 15-22, 15-31, 15-32, 15-41, and 15-42. The orchestrator 4 generates port group information T21 related to the port group 15g and transmits the information to the storage system 1.

Further, a terminal 5 including a display screen (not illustrated) is connected to the storage system 1.

In the present embodiment, the computer system S includes two physical servers 2, two switches 3, two CPUs 11, two memories 12, two switches 13, and two port groups 15g for redundancy, but the number of them is not limited to two. The number of drives 14 is changeable.

### (Configuration of Port Specification and State Management Table T1 According to the Embodiment)

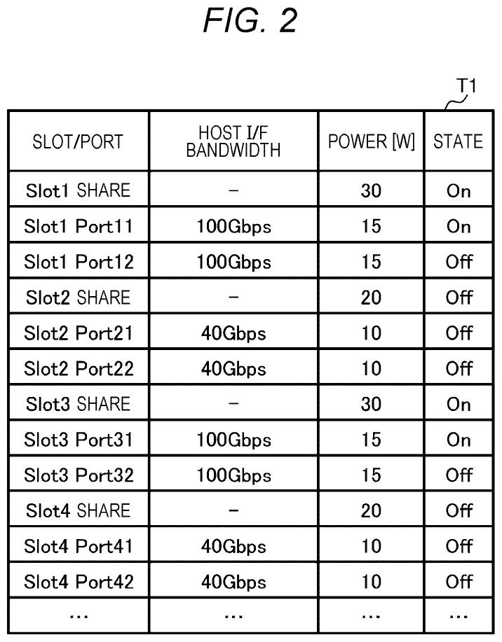

FIG. 2 shows a configuration of the port specification and state management table T1 according to the embodiment. The port specification and state management table T1 is stored in the memories 12-1 and 12-2 as one of the control data 121-1 and 121-2.

The port specification and state management table T1 manages communication bands with the physical servers 2-1 and 2-2, power consumption, and a power on-off state for each of the ports 15 mounted in slots (host I/F 151). Further, the port specification and state management table T1 manages the sum of the power consumption of the ports in the slot and the on-off state of the power supply, for each slot. The port specification and state management table T1 has columns “slot/port”, “host I/F bandwidth”, “power”, and “state”.

“Slot/port” stores identification information indicating which host I/F 151 or port 15 it is. “Slot 1 share” indicates the host I/F 151-1. “Slot 2 share” indicates the host I/F 151-2. “Slot 3 share” indicates the host I/F 151-3. “Slot 4 share” indicates the host I/F 151-4.

“Slot 1 Port 11” indicates the port 15-11. “Slot 1 Port 12” indicates the port 15-12. “Slot 2 Port 21” indicates the port 15-21. “Slot 2 Port 22” indicates the port 15-22. “Slot 3 Port 31” indicates the port 15-31. “Slot 3 Port 32” indicates the port 15-32. “Slot 4 Port 41” indicates the port 15-41. “Slot 4 Port 42” indicates the port 15-42.

The “host I/F bandwidth” is a performance specification given to the corresponding port 15, and indicates a maximum band of the communication interface on the host side (physical server 2 side). “Power” is a specification of the corresponding slot (host I/F 151) or the port 15, and indicates maximum power consumption. “State” is an operating state of the corresponding slot (host I/F 151) or the port 15, and indicates a power on-off state for each slot or for each port 15 in the slot. The “state” of the slot indicates “Off” when the power of all the ports 15 in the corresponding slot is “Off”, and indicates “On” when the power of at least one of the ports 15 is “On”.

In the example of FIG. 2, for example, as for the port specifications in “Slot 1 Port 11” (port 15-11), “host I/F bandwidth” indicates “100 Gbps”, “power” indicates “15 W”, and “state” indicates “On”. Further, in “Slot 1 Port 12” (port 15-12), “host I/F bandwidth” indicates “100 Gbps”, “power” indicates “15 W”, and “state” indicates “Off”. Therefore, in “Slot 1 share” (host I/F 151-1), “power” indicates “30 W” and “state” indicates “On”.

### (Configuration of Port Group Information Management Table T2 According to the Embodiment)

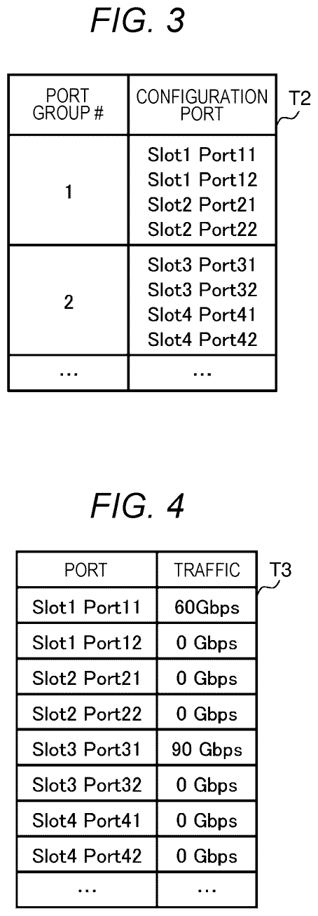

FIG. 3 shows a configuration of the port group information management table T2 according to the embodiment. The port group information management table T2 is stored in the memories 12-1 and 12-2 as one of the control data 121-1 and 121-1. The storage system 1 stores the port group information T21 received from the orchestrator 4 in the port group information management table T2.

In the example of FIG. 3, it can be found that “Slot 1 Port 11” (port 15-11), “Slot 1 Port 12” (port 15-12), “Slot 2 Port 21” (port 15-21), and “Slot 2 Port 22” (port 15-22) constitute a port group #1.

### (Port Flow Quantity Recording Table T3 According to the Embodiment)

FIG. 4 shows a configuration of the port flow quantity recording table T3 according to the embodiment. The port flow quantity recording table T3 is stored in the memories 12-1 and 12-2 as one of the control data 121-1 and 121-2. The storage system 1 measures traffic of each port 15 and records the traffic in the port flow quantity recording table T3.

In the example of FIG. 4, the traffic of “Slot 1 Port 11” (port 15-11) indicates “60 Gbps”.

### (External Data Acquisition Processing According to the Embodiment)

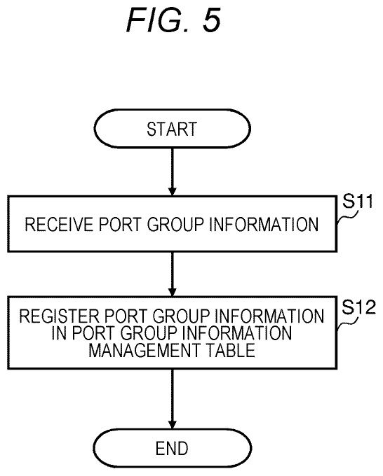

FIG. 5 is a flowchart showing the external data acquisition processing according to the embodiment. The external data acquisition processing is implemented by the CPU 11 that executes the control program 122. The external data acquisition processing is executed every time the port group information T21 is received from the orchestrator 4.

First, in step S21, the CPU 11 receives the port group information T21 from the orchestrator 4 via the management I/F 16. The port group information T21 is information generated by the orchestrator 4. In next step S22, the CPU 11 stores the port group information T21 received from the orchestrator 4 in the port group information management table T2.

### (Port Operation and Stop Processing According to the Embodiment)

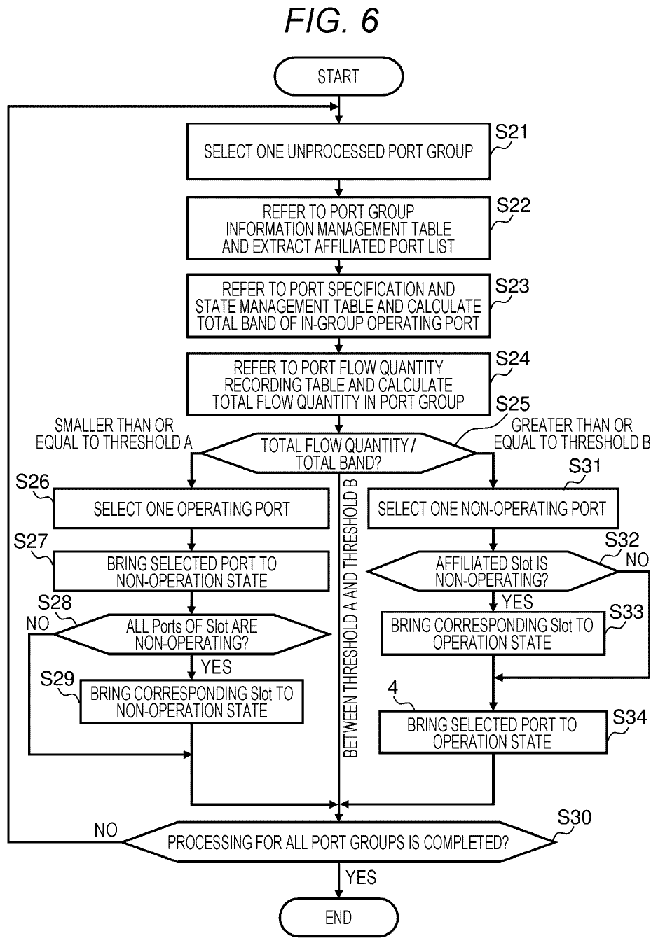

FIG. 6 is a flowchart showing the port operation and stop processing according to the embodiment. The port operation and stop processing is implemented by the CPU 11 that executes the control program 122. The port operation and stop processing is executed at a predetermined period or by instruction from a user as a trigger.

First, in step S21, the CPU 11 selects one unprocessed port group. In next step S22, the CPU 11 refers to the port group information management table T2 and extracts a list of the ports 15 belonging to the port group 15g selected in step S21.

In next step S23, the CPU 11 refers to the port specification and state management table T1 and calculates a total band of the ports 15 operating in the port group 15g extracted in step S22. For example, in the case of the port group 15g-1 (port group #1), in the example of FIG. 2, the total band of “Slot 1 Port 11” (port 15-11), “Slot 1 Port 12” (port 15-12), “Slot 2 Port 21” (port 15-21), and “Slot 2 Port 22” (port 15-22) is such that 100+100+40+40=280 Gbps.

In next step S24, the CPU 11 refers to the port flow quantity recording table T3 and calculates a total flow quantity of the ports 15 operating in the port group 15g extracted in step S22. For example, in the case of the port group 15g-1 (port group #1), in the example of FIG. 4, the total flow quantity of “Slot 1 Port 11” (port 15-11), “Slot 1 Port 12” (port 15-12), “Slot 2 Port 21” (port 15-21), and “Slot 2 Port 22” (port 15-22) is such that 60+0+0+0=60 Gbps.

In next step S25, the CPU 11 calculates a ratio of the total flow quantity calculated in step S24 to the total band calculated in step S23, and compares the ratio with a threshold. In a case where the above-described ratio is smaller than or equal to a threshold A (that is, in a case where the utilization of the band is low), the CPU 11 causes the processing to go to step S26, and in a case where the ratio exceeds the threshold A and is smaller than a threshold B, the CPU causes the processing to go to step S30. On the other hand, in a case where the ratio is greater than or equal to the threshold A (that is, in a case where the utilization of the band is high), the CPU 11 causes the processing to go to step S31.

In step S26, the CPU 11 selects one port 15 in operation from the ports belonging to the port group 15g that has been selected in step S21 and is to be controlled.

In next step S27, the CPU 11 brings the port in operation selected in step S26 to a non-operate state.

In next step S28, the CPU 11 determines whether there exists a slot in which all the mounted ports 15 are non-operating (state” indicates “Off”) among the slots (the host I/F 151) belonging to the port group 15g selected in step S21. In a case where there exists the slot in which all the ports are non-operating (“state” indicates “Off”) (YES in step S28), the CPU 11 causes the processing to go to step S29. On the other hand, in a case where there exists the slot in which all the ports are non-operating (“state” indicates “Off”) (No in step S28), the CPU 11 causes the processing to go to step S30.

In step S29, the CPU 11 brings the slot (host I/F 151) in which the determination is made in step S28 that all the ports 15 are non-operating to the non-operating state (“state” indicates “Off”).

When step S29 ends, the CPU 11 causes the processing to go to step S30.

In step S30, the CPU 11 determines whether the processing has been completed for all the port groups 15g in the storage system 1. In a case where the processing has been completed for all the port groups 15g (YES in step S30), the CPU 11 ends the port operation and stop processing. On the other hand, in a case where there exists an unprocessed port group 15g (NO in step S30), the CPU 11 returns the processing to step S21.

In step S31, the CPU 11 selects one non-operating port from the ports 15 belonging to the port group 15g that has been selected in step S21. In next step S32, the CPU 11 determines whether the slot (host I/F 151) equipped with the non-operating port selected in step S31 is in non-operation (“state” indicates “Off”). In a case where the corresponding slot is in non-operation (YES in step S32), the CPU 11 causes the processing to go to step S33. In a case where the corresponding slot is in operation (No in step S32), the CPU 11 causes the processing to go to step S34.

In step S33, the CPU 11 operates the corresponding slot (host I/F 151) determined to be in non-operation in step S32. In next step S34, the CPU 11 operates the non-operating port selected in step S31.

Upon completion of step S34, the CPU 11 causes the processing to go to step S30.

Note that, in step S26, any port 15 is selected from the operating ports. However, the present invention is not limited thereto, and the ports 15 may be selected in order in which the values of “host I/F bandwidth” and “power” (port specification and state management table T1 (FIG. 2)) are larger (that is, power efficiency (host I/F bandwidth/power [Gbps/W]) is lower). As a result, even when the specification and performance are not uniform in the ports 15 belonging to the port group 15g, the power can be efficiently reduced by sequentially stopping the ports 15 in descending order of power reduction effect.

In steps S26 to S29, the ports 15 are brought to the non-operation state one by one, but a combination of the port 15 having the highest power efficiency at the current total flow quantity of the target port group 15g may be selected at a time. The ports 15 and the host I/Fs 15a and 15b other than this combination may be simultaneously brought to the non-operation state.

In step S31, any port 15 is selected from the non-operating ports. However, the present invention is not limited thereto, and the ports 15 may be selected in order in which the values of “host I/F bandwidth” and “power” (port specification and state management table T1 (FIG. 2)) are smaller (that is, the power efficiency (host I/F bandwidth/power [Gbps/W]) is higher). This can achieve both the operation of the ports 15 and the suppression of the power consumption even in a case where the specification and performance are not uniform in the ports 15 belonging to the port group 15g.

Further, in steps S31 to S34, the ports 15 are brought to the operation state one by one, but the combination of the port 15 having the highest power efficiency at the current total flow quantity of the target port group 15g may be selected at a time. The ports 15 and the host I/Fs 15a and 15b corresponding to this combination may be simultaneously operated.

Further, at the completion of the port operation and stop processing, the CPU 11 may transmit, to the orchestrator 4, a state change notification regarding the operation and non-operation of the host I/F 151 and the port 15 in the port operation and stop processing. Then, the CPU 11 may instruct the orchestrator 4 to perform rebalancing to change the port 15 to be the connection destination accessed by the physical server 2 in response to the state change notification. As a result, even in a specification in which the physical server 2 side does not automatically follow the port control on the storage system 1 side, the orchestrator 4 can execute port balancing.

### (Storage State Display Screen 5D According to the Embodiment)

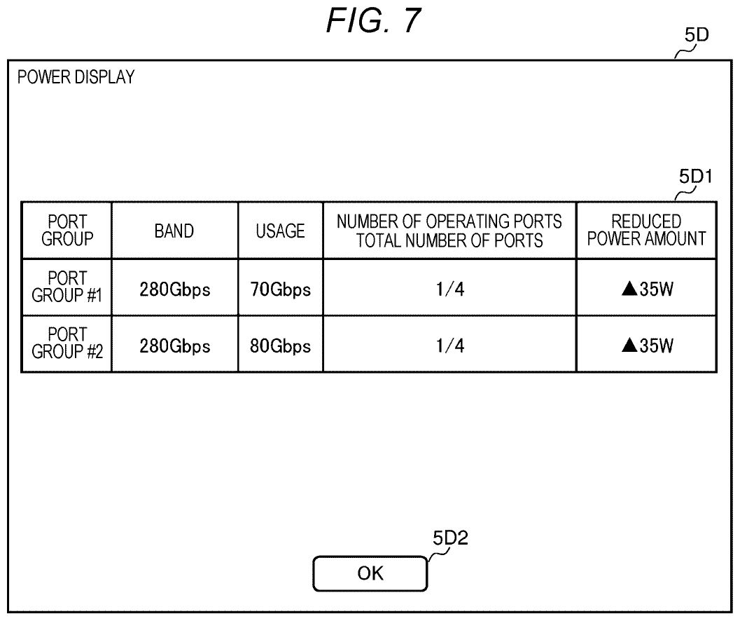

FIG. 7 is a diagram illustrating a configuration of the storage state display screen 5D according to the embodiment. The storage state display screen 5D includes a storage state display region 5D1 and an OK button 5D2. The storage state display screen 5D is displayed at a timing of calling by the user or the program, and is closed when the OK button 5D2 is pressed.

The storage state display region 5D1 has columns “port group”, “band”, “usage”, “number of operating ports/total number of ports”, and “reduced power amount”.

“Port group” is identification information about the port groups 15g. “Band” is the sum of bands of all the ports 15 belonging to the corresponding “port group” (“host I/F bandwidth” of the port specification and state management table T1 (FIG. 2)). “Usage” is the sum of the usage bands of all the ports 15 belonging to the corresponding “port group” (“traffic” in the port flow quantity recording table T3 (FIG. 4)).

“Number of operating ports/total number of ports” is the number of operating ports 15/the number of all ports belonging to the corresponding “port group”. “Reduced power amount” is the cumulative amount of the power consumption that can be reduced after a reference time in each of the corresponding port groups by executing the port operation and stop processing (FIG. 6).

Note that “band”, “usage”, and “reduced power amount” are not limited to be displayed for each port group, and may be displayed for each slot (host I/Fs 15a and 15b) or each port 15. Similarly, “number of operating ports/total number of ports” is not limited to be displayed for each port group, and may be displayed for each slot (host I/Fs 15a and 15b). When the button provided on the storage state display screen 5D is pressed by the user, the display unit of “band”, “usage”, “number of operating ports/total number of ports”, and “reduced power amount” are switched.

### (Effects of Embodiment)

In the above-described embodiment, the actual communication load at the time of the access from the host, such as the virtual machine 21 or the virtual server operating in a virtual environment on the physical server 2, to the storage system is measured for each port group 15g. For each port group 15g, the communication load is compared with the sum of the communication bands of the ports 15 included in each port group 15g. The power consumption of the interface device (host I/F 151) is controlled based on the comparison result between the communication load and the sum of the communication bands. Therefore, according to the embodiment, by operating a necessary and sufficient interface device in accordance with the load from the host, it is possible to reduce the power consumption of the interface device occupying a certain level or more in the storage system.

Further, in the above-described embodiment, the power on-off control is made for the ports 15 included in each port group 15g, based on the comparison result between the communication load and the sum of the communication bands. Therefore, according to the embodiment, the power consumption can be finely reduced for each ports 15.

Further, in the above-described embodiment, in a case where the power of the interface device (host I/F 151) is off at the time of the power on/off control for the ports 15 in each port group 15g, the power of the ports 15 of the interface device is turned on after the power of the interface device is turned on. On the other hand, after the power of all the ports 15 included in the interface device is turned off, the power of the interface device is turned off. Therefore, according to the embodiment, the power of the interface device itself in which the power of all the ports 15 is turned off is also turned off, thereby further reducing the power consumption.

In the above-described embodiment, the instruction to execute the rebalancing processing including the change of the port 15 accessed by the virtual machine 21 or the like is transmitted to the virtualization infrastructure management system that manages the virtual environment, in accordance with the control result of the power consumption of the interface device (host I/F 151). The virtualization infrastructure management system is, for example, the orchestrator 4. The virtualization infrastructure management system executes the rebalancing processing based on the instruction to execute the rebalancing processing. To change the port 15 accessed by the server is, for example, to change the port group so that the powered-off port 15 is not accessed but the powered-on port 15 is accessed. Therefore, according to the embodiment, in a case where the virtualization infrastructure management system or the host does not automatically follow the increase or decrease attendant on the power on/off for the port 15, the computer system S is enabled to follow the increase or decrease attendant on the power on/off for the port 15 by the user making manual control.

Although the embodiment has been described above, this is an example for describing the present invention, and it is not intended to limit the scope of the present invention only to this embodiment. The present invention can also be implemented in various other forms, such as a form excluding a part of a configuration of a certain embodiment, or a form in which a part or all of the configurations in a plurality of embodiments are combined.

What is claimed is:

1. A storage system that provides a storage area to a host operating in a virtual environment, the storage system comprising:
an interface device including a port connected to communicate with the host;
a processor; and
a memory,
wherein a plurality of the ports configure port groups, the plurality of ports serving as connection destinations at a time of an access from the host to the storage system, and
wherein the processor
measures, for each of the port groups, an actual communication load on each of the plurality of ports at the time of the access from the host to the storage system,
compares, for each of the port groups, the communication load with a sum of communication bands of the plurality of ports included in each of the port groups, and
controls power consumption of the interface device based on a comparison result between the communication load and the sum of the communication bands.

2. The storage system according to claim 1, wherein the processor makes power on/off control for the ports included in each of the port groups, based on the comparison result between the communication load and the sum of the communication bands.

3. The storage system according to claim 2, wherein
the processor,
when making the power on/off control for the ports included in each of the port groups,
turns on the power of the ports included in the interface device after turning on power of the interface device in a case where the power of the interface device is off, and
after turning off the power of all the ports included in the interface device, turns off the power of the interface device.

4. The storage system according to claim 1, wherein
the processor transmits an instruction to execute rebalancing processing including a change of the port accessed by the host to a virtualization infrastructure management system that manages the virtual environment, based on a control result of the power consumption of the interface device, and
wherein the virtualization infrastructure management system executes the rebalancing processing based on the instruction to execute the rebalancing processing.

5. A computer system, comprising:
a host that operates in a virtual environment;
a virtualization infrastructure management system that manages the virtual environment; and
a storage system that provides a storage area to the host,
wherein the storage system includes an interface device including a port connected to communicate with the host, a processor, and a memory,
wherein a plurality of the ports configure port groups, the plurality of ports serving as connection destinations at a time of an access from the host to the storage system,
wherein the processor
measures, for each of the port groups, an actual communication load at the time of the access from the host to the storage system,
compares, for each of the port groups, the communication load with a sum of communication bands of the plurality of ports included in each of the port groups, and
controls power consumption of the interface device based on a comparison result between the communication load and the sum of the communication bands, and
wherein the virtualization infrastructure management system executes, on the host, rebalancing processing including a change of the port accessed by the host, based on a control result of the power consumption of the interface device.

6. A control method for a storage system, the method being executed by the storage system providing a storage area to a host operating in a virtual environment,
the storage system including an interface device including a port connected to communicate with the host, a processor, and a memory,
a plurality of the ports configuring port groups, the plurality of ports serving as connection destinations at a time of an access from the host to the storage system,
the control method causing the processor to perform operations comprising:
measuring, for each of the port groups, an actual communication load on each of the plurality of ports at the time of the access from the host to the storage system;
comparing, for each of the port groups, the communication load with a sum of communication bands of the plurality of ports included in each of the port groups; and
controlling power consumption of the interface device based on a comparison result between the communication load and the sum of the communication bands.
